(19) United States
(12) Patent Application Publication
(10) Pub. No.: US 2026/0093597 A1
(43) Pub. Date: Apr. 2, 2026

(54) SYSTEMS AND METHODS FOR MONITORING AND PREDICTING TECHNOLOGY COMPONENT PERFORMANCE AND GENERATING REAL TIME ALERTS

(71) Applicant: BANK OF AMERICA CORPORATION, CHARLOTTE, NC (US)

(72) Inventors: John Andres Lozes, Wilmington, DE (US); Aaron Gee, Palm Coast, FL (US); Aisha Jenkins, Atlanta, GA (US); Andrea M. Weisberger, Jacksonville, FL (US); Aravind Singtalur, McKinney, TX (US); Manonmani Palanichamy, Fort Mill, SC (US); Naresh Kumar Petapalle, Greater London (GB); Mohammad Saleem Gaziani, Plano, TX (US); Tonya Kyra Miller, Charlotte, NC (US); Amer Ali, Jersey City, NJ (US)

(73) Assignee: BANK OF AMERICA CORPORATION, CHARLOTTE, NC (US)

(21) Appl. No.: 18/903,660

(22) Filed: Oct. 1, 2024

(51) Int. Cl. G06F 11/34; G06F 11/30; G06F 11/32

(52) U.S. Cl. CPC G06F 11/3452; G06F 11/3065; G06F 11/324

(57) ABSTRACT

Systems, computer program products, and methods are described herein for monitoring and predicting technology component performance and generating real time alerts. The present disclosure is configured to collect, from at least one source component, metric data at a pre-defined interval; cluster the metric data into at least one bucket based on a type of the metric data and the pre-defined interval; collect historical metric data associated with the at least one source component at a plurality of historical pre-defined intervals; apply the at least one bucket and the historical metric data associated with the at least one source component to a prediction module; and determine, by the prediction module, a predicted trend for the at least one source component.

### TECHNOLOGICAL FIELD

Example embodiments of the present disclosure relate to monitoring and predicting technology component performance and generating real time alerts.

### BACKGROUND

In today's current technology environment, so many components perform so many tasks to keep applications, data centers, servers, and/or the like up and running, and running smoothly without interruption. However, it is extremely difficult for operators of these technical components, operators of these applications, data centers, servers, and/or the like to be aware of each potential performance issue as they occur—in real time—and be aware of potential trends for future performance issues. In both instances, these operators of these technical environments must be efficient and accurate with determining when issues arise—in real time or near real time—and when the issues are likely to arise again. Thus, a system that can monitor and predict technology component performance and generate real time alerts in an efficient, accurate, and dynamic way is necessary to keep these technical environments and their downstream components and applications running smoothly and without interruption.

Applicant has identified a number of deficiencies and problems associated with determining current performance metrics of technology components and predicting future performance metrics of technology components. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for monitoring and predicting technology component performance and generating real time alerts monitoring and predicting technology component performance and generating real time alerts.

In one aspect, a system for monitoring and predicting technology component performance and generating real time alerts is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: collect, from at least one source component, metric data at a pre-defined interval; cluster the metric data into at least one bucket based on a type of the metric data and the pre-defined interval; collect historical metric data associated with the at least one source component at a plurality of historical pre-defined intervals; apply the at least one bucket and the historical metric data associated with the at least one source to a prediction module; and determine, by the prediction module, a predicted trend for the at least one source component.

In some embodiments, the prediction module comprises at least one of a least squares regression algorithm, a linear regression algorithm, a polynomial regression algorithm, a KMeans clustering algorithm, or a stepwise regression algorithm.

In some embodiments, the predicted trend comprises a linear trend.

In some embodiments, the pre-defined interval comprises at least one of a five minute interval, a minute interval, a ten minute interval, a fifteen minute interval, a thirty minute interval, or an hour interval.

In some embodiments, executing the computer-readable code is further configured to cause the at least one processing device to: generate a dashboard interface component comprising the metric data associated with the at least one source component at a current instance; transmit the dashboard interface component to a user device associated with the at least one source component, wherein the user device comprises a graphical user interface; and trigger a configuration of the graphical user interface of the user device with the dashboard interface component.

In some embodiments, executing the computer-readable code is further configured to cause the at least one processing device to: generate a prediction interface component comprising the predicted trend for the at least one source component; transmit the prediction interface component to a user device associated with the at least one source component, wherein the user device comprises a graphical user interface; and trigger a configuration of the graphical user interface of the user device with the prediction interface component.

In some embodiments, executing the computer-readable code is further configured to cause the at least one processing device to: determine a difference score between at least one of the metric data in the at least one bucket or the predicted trend and the historical metric data associated with the at least one source component; and compare the difference score to a difference threshold. In some embodiments, executing the computer-readable code is further configured to cause the at least one processing device to: determine, based on the comparison of the difference score and the difference threshold, the difference score meets or exceeds the difference threshold; generate an alert interface component comprising the difference score and the at least one of the metric data or the predicted trend the difference score is based on; transmit the alert interface component to a user device associated with the at least one source component, wherein the user device comprises a graphical user interface; and trigger a configuration of the graphical user interface of the user device with the alert interface component. In some embodiments, executing the computer-readable code is further configured to cause the at least one processing device to: determine, based on the comparison of the difference score and the difference threshold, the difference score does not meet or exceed the difference threshold; and update a dashboard interface component with the difference score, wherein the dashboard interface component further comprises the metric data associated with the at least one source component at a current instance with the difference score.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for monitoring and predicting technology component performance and generating real time alerts, in accordance with an embodiment of the disclosure;

FIG. 2 illustrates a process flow for monitoring and predicting technology component performance and generating real time alerts, in accordance with an embodiment of the disclosure;

FIG. 3 illustrates a process flow for triggering a configuration of a graphical user interface of a user device with a dashboard interface component, in accordance with an embodiment of the disclosure;

FIG. 4 illustrates a process flow for trigging a configuration of a graphical user interface of a user device with a prediction interface component, in accordance with an embodiment of the disclosure;

FIG. 5 illustrates a process flow for comparing the difference score to a difference threshold and updating a graphical user interface with an alert interface component or a dashboard interface component, in accordance with an embodiment of the disclosure; and

FIG. 6 illustrates a flow diagram for monitoring and predicting technology component performance and generating real time alerts, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's current technology environment, so many components perform so many tasks to keep applications, data centers, servers, and/or the like up and running, and running smoothly without interruption. However, it is extremely difficult for operators of these technical components, operators of these applications, data centers, servers, and/or the like to be aware of each potential performance issue as they occur—in real time—and be aware of potential trends for future performance issues. In both instances, these operators of these technical environments must be efficient and accurate with determining when issues arise—in real time or near real time—and when the issues are likely to arise again. Thus, a system that can monitor and predict technology component performance and generate real time alerts in an efficient, accurate, and dynamic way is necessary to keep these technical environments and their downstream components and applications running smoothly and without interruption.

Further, and importantly, when these issues typically occur in these technical environments, the issues often occur at particular times (e.g., particular days of the week, particular time on a particular day, and/or the like) which itself can be hard to pinpoint or predict when an operator is reviewing all the data for the technical component over the entire day instead of in chunks at particular times, and over an extended period (e.g., on a monthly basis, on a weekly basis, and/or the like). It can be difficult for operators to manually review the metric data of each technical component, application, server, data center, and/or the like, that they're responsible for as the volume of data can be immense and the operator may only review each piece of data in a vacuum or in an isolated instance instead of comparing the data to past or historical trends in the metric data.

Thus, the disclosure provided herein provides for the collection—from at least one source component—of metric data at a pre-defined interval; the clustering of the metric data into at least one bucket based on a type of the metric data and the pre-defined interval; and the collection of historical metric data associated with the at least one source component at a plurality of historical pre-defined intervals. Further, the disclosure provides for the application of the at least one bucket and the historical metric data associated with the at least one source component to a prediction module; and the determination, by the prediction module, of a predicted trend for the at least one source component.

In other words, the disclosure provides a system that uses aggregated historical data and trend prediction algorithms to identify significant changes over the historical period and/or future periods based on past trends. In some important instances, the system may determine and predict CPU utilization trends, response time of servers and applications trends, and/or data transmissions served by particular servers or data centers and their trends. In some embodiments, and based on the current trend and/or future trends, the system may automatically generate reports and alerts to handle problematic trends.

What is more, the present disclosure provides a technical solution to a technical problem. As described herein, the technical problem includes the determination of current performance metrics of technology components and the prediction of future performance metrics of technology components. The technical solution presented herein allows for accurate, efficient, and dynamic monitoring and prediction of technology component performance and generation of real time alerts. In particular, the disclosure provided herein is an improvement over existing solutions to the monitoring and prediction of technical component performance, (i) with fewer steps to achieve the solution, thus reducing the amount of computing resources, such as processing resources, storage resources, network resources, and/or the like, that are being used (e.g., by only analyzing portions of the metadata, such as portions of the metric data and historical metric data in five minute buckets, the system is able to analyze less data and use less resources in collected and processing larger amounts of data); (ii) providing a more accurate solution to problem, thus reducing the number of resources required to remedy any errors made due to a less accurate solution (e.g., by using the prediction module, which is configured to determine a predicted trend accurately and efficiently without needed excessive data); (iii) removing manual input and waste from the implementation of the solution, thus improving speed and efficiency of the process and conserving computing resources (e/g., by allowing the system to analyze the metric data and the historical metric data in buckets comprising pre-determined time intervals); (iv) determining an optimal amount of resources that need to be used to implement the solution, thus reducing network traffic and load on existing computing resources (e.g., by determining when an alert interface component should be sent, and in some instances, determining the correct user device to directly receive the alert interface component, the system determines the optimal amount of resources to generate the alert and transmit the alert). Furthermore, the technical solution described herein uses a rigorous, computerized process to perform specific tasks and/or activities that were not previously performed. In specific implementations, the technical solution bypasses a series of steps previously implemented, thus further conserving computing resources.

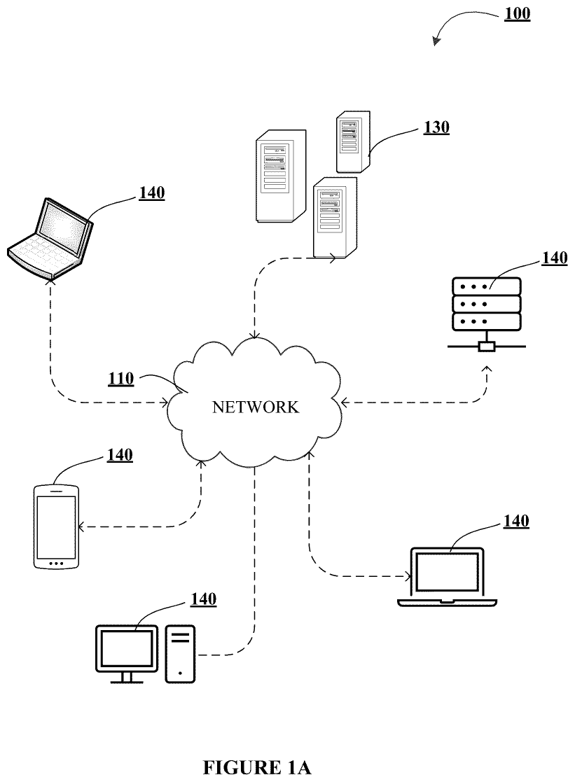

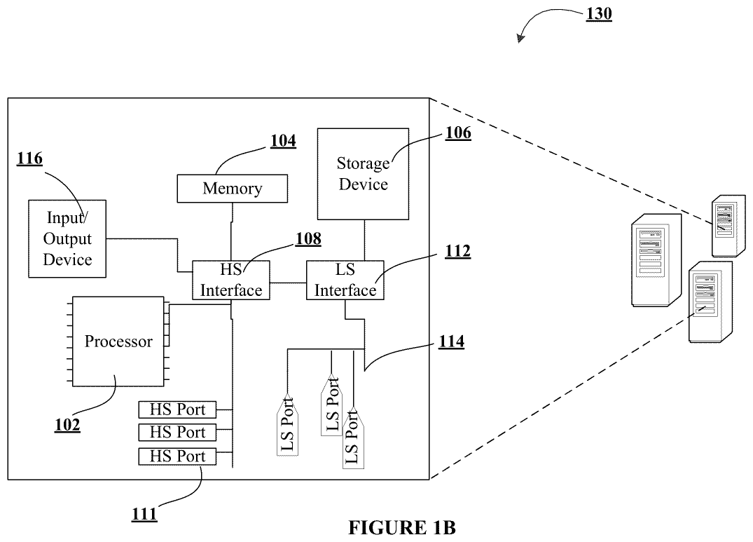

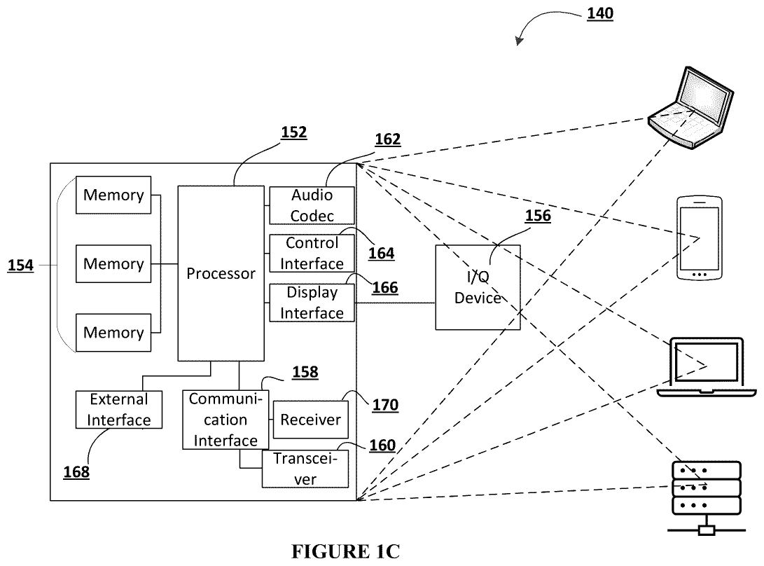

FIGS. 1A-1C illustrate technical components of an exemplary distributed computing environment for monitoring and predicting technology component performance and generating real time alerts 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

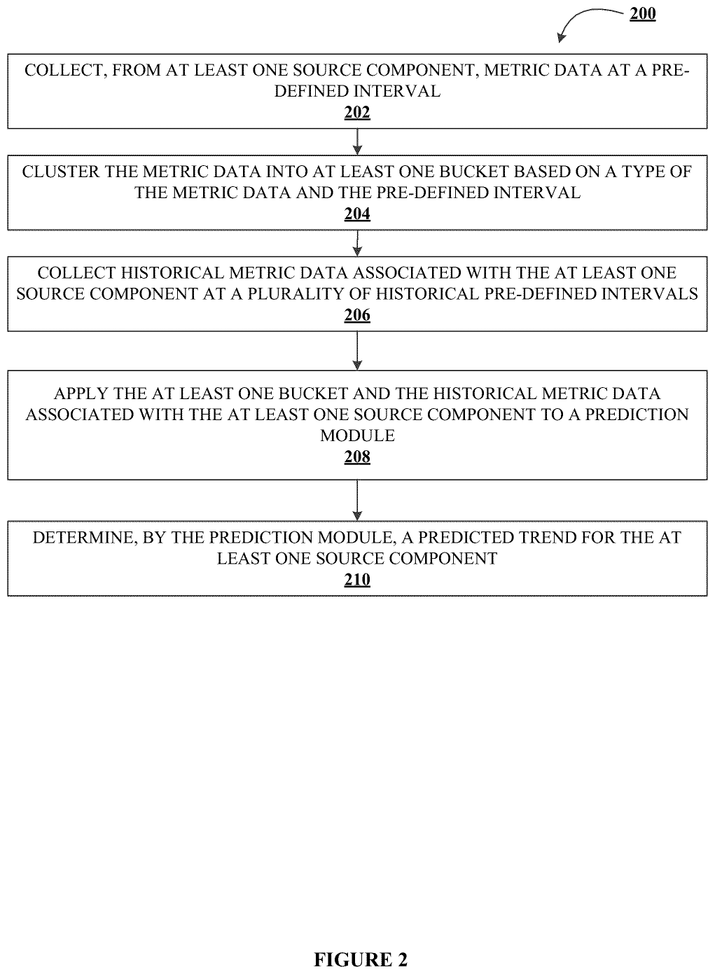

FIG. 2 illustrates a process flow 200 for monitoring and predicting technology component performance and generating real time alerts, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process flow 200.

As shown in block 202, the process 200 may include the step of collecting, from at least one source component, metric data at a pre-defined interval. For example, the system may collect and/or receive data from at least one source component in a network associated with the system (e.g., a network connected to the system, a network housing the system, a network sending and/or receiving data transmission to and/or from the system, and/or the like). In some such embodiments, the at least one source component may comprise an application, a website, a data center, a data center component, a central processing unit (CPU), a server, a container, an environment, and/or the like. Additionally, and in some such embodiments, the metric data collected and/or received by the system may comprise, but is not limited to, at least one of response time for the at least one source component, heat data of the at least one source component, unresponsiveness of the source component, losses of data transmission requests and data loss, execution errors, runtime errors, syntax errors, communication errors, hardware errors, compilation errors, arithmetic errors, linker errors, semantic errors, execution errors, logical operator errors, memory errors, component failure, power outages, network failures, security breaches, and/or the like.

In some embodiments, the system itself may collect and separate or organize all the metric data as the metric data is received from a network (and/or from the at least one source component directly via a network). In some embodiments, the at least one source component may be configured (e.g., programmed) to automatically and continuously transmit its metric data to the system for continuous collection. In some embodiments, the at least one source component may be configured (e.g., programmed) to automatically transmit its metric data to the system at pre-defined intervals, such as but not limited to every minute, every five minutes, every six minutes, every ten minutes, every fifteen minutes, every thirty minutes, every hour, and/or the like. Additionally, and/or alternatively, the system itself may be programmed to send data transmission requests to the at least one source components for the source component's metric data and receive, based on the data transmission requests, the metric data from each source component. Such data transmission requests may be generated and transmitted at the pre-defined intervals described hereinabove. Thus, and in such embodiments where data is collected a pre-defined intervals, the system may avoid analyzing too much data as opposed to a continuous collection of data from the at least one source component(s).

In some embodiments, the pre-defined interval as described herein is configurable based on a user input, such as a user input received at a user device associated with the system (e.g., a user device associated with a manager of the system, a user device associated with a manager of the at least one source component, and/or the like). Thus, and in some such embodiments, the pre-defined interval may change based on a user input requesting less data or more data to be collected from the at least one source component and analyzed by the system described herein.

As shown in block 204, the process flow 200 may include the step of clustering the metric data into at least one bucket based on a type of the metric data and the pre-defined interval. For instance, and in some embodiments, the system may cluster or separate the metric data collected from the source component(s) into at least one bucket(s), whereby each bucket may store a particular type of error within the metric data for each source component. Thus, and as described herein, each bucket may comprise all the errors of the same type at the same pre-defined interval for the same source component. In some such embodiments, the system may cluster the metric data collected into a plurality of buckets, whereby each bucket comprises all the errors of the same type at the same pre-defined interval for each same source component. Thus, and based on the description provided herein, the system may segment or cluster the errors from the collected metric data into their respective buckets, and the system may perform an analysis on each bucket to determine a count of each error type at the pre-defined interval for each source component.

By way of non-limiting example, and where the pre-defined interval is set at five minutes, the at least one source component the metric data was collected from comprises a server A, server B, server C, and a server D, and server A has execution errors and runtime errors in that pre-defined interval, server B also has execution errors and linker errors in that pre-defined interval, server C has linker errors and runtime errors, and server D has hardware errors at component A and loss of data errors. Then, in such an example, the system may generate a plurality of buckets, whereby a first bucket may comprise the execution errors for server A, the second bucket may comprise the runtime errors for server A, the third bucket may comprise the execution errors for server B, the fourth bucket comprises the linker errors for server B, the fifth bucket comprises the linker errors for server C, the sixth bucket comprises the runtime errors for server C, the seventh bucket comprises hardware errors for component A for server D, and the eighth bucket comprises the loss of data errors for server D. In some embodiments, and where server D has hardware errors for multiple components (e.g., component A and component B), then the system may generate multiple buckets for the multiple components (e.g., a bucket for the hardware errors of component A and a bucket for the hardware errors of component B).

Thus, and as used herein, the term “bucket” refers a memory component configured or programmed to store data records. Such buckets may be configured to store data for each pre-defined interval and for each source component, which allows the system to segment the data for each source component for separate analysis against each source component's past or historical data, without muddling the data for each bucket with data belonging to another source component or another error. Thus, the data within each bucket is refined and limited for greater processing speed, lower storage requirements, and to provide greater accuracy in the system's analysis for each source components (e.g., to determine predicted trends for each source component in an accurate and efficient manner).

As shown in block 206, the process flow 200 may include the step of collecting historical metric data associated with the at least one source component at a plurality of historical pre-defined intervals. For instance, the system may collect historical metric data associated with source component analysis and used to generate the buckets provided hereinabove for the pre-defined interval. Additionally, and/or alternatively, the system may collect the historical metric data for all the source components associated with the system (e.g., the source components previously or historically transmitted their metric data to the system), such that the system keeps a running database and/or a running storage of the historical data from each connected source component.

In some embodiments, the database and/or storage component that continuously collects the historical data for each source component may be operatively coupled to the system itself, managed by the system, and/or located remote from the system (e.g., such that the system sends a data transmission request over a network to the database and/or storage component for the historical metric data). In some embodiments, and where the system sends a data transmission request to the remote storage component and/or database for the historical metric data, the system may limit its data transmission request(s) to only those source components and their historical metric data that are current associated with a bucket from block 204. Thus, and in this manner, the system may limit its historical metric data necessary to analyze the buckets of the source components that currently have errors that were sorted into a bucket, and thus, the system may analyze only the necessary data for each source component and not extra or unimportant data to generate a predicted trend.

In some embodiments, and in order to generate a wholistic view of all the source components considered by the system, the system may cluster each piece of data from the metric data collected into their respective buckets, such that all the metric data for each source component is considered to generate the predicted trend (even data that may not comprise or indicate any errors). In such embodiments, the historical metric data for the source components may collected to generated predicted trends for all the source components, even the source components that do not comprise or indicate any errors.

Further, and in some embodiments, the system may collect the historical metric data at the same pre-defined interval configured from blocks 202-204. Thus, and in the example provided hereinabove, where the pre-defined interval was five minutes, the historical pre-defined interval may also be five minutes. Such a matching of the pre-defined interval and the historical pre-defined interval may allow the system to use the historical metric data collected at the same time periods as a controlled set of data for the source component(s).

As shown in block 208, the process flow 200 may include the step of applying the at least one bucket and the historical metric data associated with the at least one source component to a prediction module. For example, the system may apply the at least one bucket and the historical metric data to a prediction module, whereby the prediction module may be configured or programmed to generate a predicted trend for the source component(s), individually. In some embodiments, the prediction module may comprise at least one of a least squares regression algorithm, a linear regression algorithm, a polynomial regression algorithm, a KMeans clustering algorithm, and/or a stepwise regression algorithm.

Such a least squares regression algorithm may refer to a regression analysis that determines a line of best fit between the data points of the historical metric data and the bucket for the source component, such that the least squares regression algorithm can accurately and efficiently determine a predicted trend for each source component associated with each bucket. Thus, and in such embodiments, the least squares regression may fit the predicted trend link to the data points of the historical metric data for each type of data of each bucket, such that the sum of the squared vertical distances between the predicted trend line (i.e., a linear trend) and the data points are as small as possible, while remaining linear. Thus, and as used herein, the prediction module may generate a predicted trend for each type of data associated with each bucket for each source component. By way of non-limiting example and similar to the example provided hereinabove, where source component A was associated with a first bucket and a second bucket, then the system may generate a predicted trend for both the first bucket and the second bucket, individually. Additionally, and/or alternatively, the prediction module may comprise a stepwise regression algorithm which may comprise an iterative process that examines each of the predicted trend data points (e.g., within at least one linear trend line) generated by the linear regression algorithm and determines the significance of each predicted trend data point to determine the most important or significant predicted trend data points to generate an optimal predicted trend line.

In some embodiments, the prediction module may comprise a linear regression algorithm which may use the metric data of the bucket(s) and the historical metric data associated with the bucket(s) to generate a linear prediction line or function based on identifying a linear relationship between the data points of the metric data in the bucket(s) and the historical metric data. Additionally, and in some embodiments, the prediction module may comprise a polynomial regression algorithm which may comprise a statistical method that models a non-linear relationship between the data points of the metric data of the bucket(s) and the historical metric data to generate the predicted trend.

As shown in block 210, the process flow 200 may include the step of determining, by the prediction module, a predicted trend for the at least one source component. For example, the system may determine—using the prediction module—a predicted trend(s), such as a predicted trend line and/or the like, to show the predicted trend and/or current data of the source component(s). For instance, the system may determine and/or generate the predicted trend for each bucket associated with the collected metric data, whereby the predicted trend(s) may comprise a linear trend generated by the prediction module. Thus, and as used herein, the system may use the predicted trend to analyze the current performance of the source component(s), and the predicted performance at a future time for the source component(s), in real time or near real time to collecting the metric data.

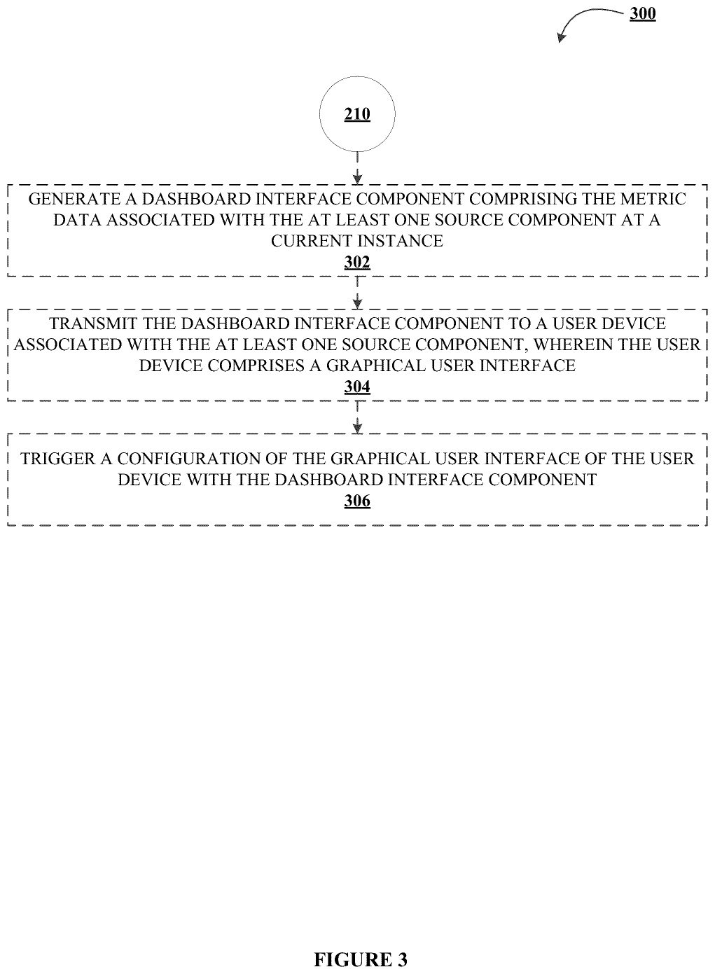

FIG. 3 illustrates a process flow 300 for triggering a configuration of a graphical user interface of a user device with a dashboard interface component, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process flow 300.

In some embodiments, and as shown in block 302, the process flow 300 may include the step of generating a dashboard interface component comprising the metric data associated with the at least one source component at a current instance. For example, and in some such embodiments, the system may generate a dashboard interface component comprising the current data or metric data of the source component(s) at a current instance. Further, and in some such embodiments, the dashboard interface component may comprise the metric data in a computer figurable format, such that the metric data may be used to render a graphical user interface (GUI) of a user device that receives the dashboard interface component with the information of the metric data. Thus, and in some such embodiments, the metric data in the dashboard interface component may comprise computer readable data which may be used to render the GUI of the user device to show the metric data in a human-readable format.

In some embodiments, and as shown in block 304, the process flow 300 may include the step of transmitting the dashboard interface component to a user device associated with the at least one source component, wherein the user device comprises a graphical user interface. For example, and in some such embodiments, the system may transmit the dashboard interface component to a user device via a network (similar to the network shown and described above with respect to FIG. 1A). Such a user device may be associated with the source component (e.g., a user device associated with an entity that operates and/or owns the source component), a user device associated with the system (e.g., a user device associated with an entity that operates the system), and/or the like. For instance, and in some such embodiments, the system may transmit the dashboard interface component to a user device, whereby the user device may be associated with a manager of a manager of the system; a manager, operator, or owner of the at least one source component; and/or the like. In some such embodiments, the user device that will receive the dashboard interface component may be pre-determined and set within the system (e.g., by a manager of the system selecting a user device and/or an associated user to receive the dashboard interface component and/or by a manager of the source component(s) selecting the user device and/or the associated user to receive the dashboard interface component). In some embodiments, the dashboard interface component may be automatically transmitted to the user device in real time or near real time once the dashboard interface component has been generated and/or updated.

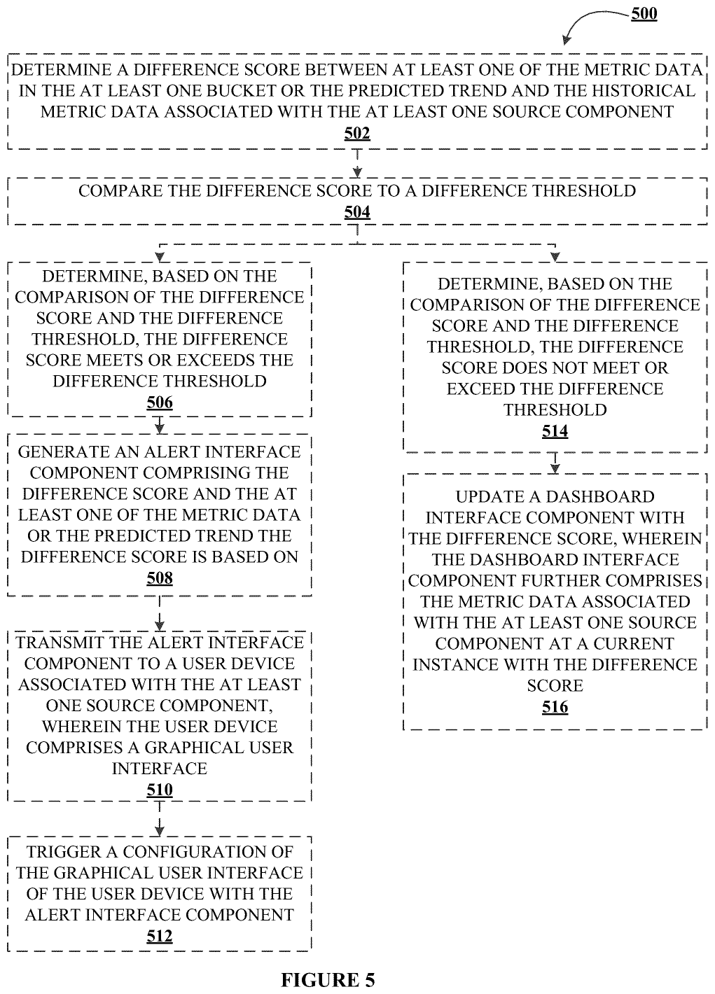

In some embodiments, and as shown in block 306, the process flow 300 may include the step of triggering a configuration of the graphical user interface of the user device with the dashboard interface component. For instance, and in some such embodiments, the system may trigger a configuration of the GUI of the recipient user device to automatically and in real time or near real time show the data of the metric data at the current instance for the at least one source component to a user of the user device. In some such embodiments, the dashboard interface component may comprise a plurality of source components and their metric data, such that the configured GUI of the user device is not limited to only one source component and its current metric/performance data. In some embodiments, the dashboard interface component may comprise at least one alert indicating when the data points of the metric data (e.g., current data point at the current instance) are above a difference threshold from previous or historical metric data (e.g., which would indicate a major change to the performance of the source component at the current time). Such an embodiment is discussed in further detail hereinbelow with respect to FIG. 5.

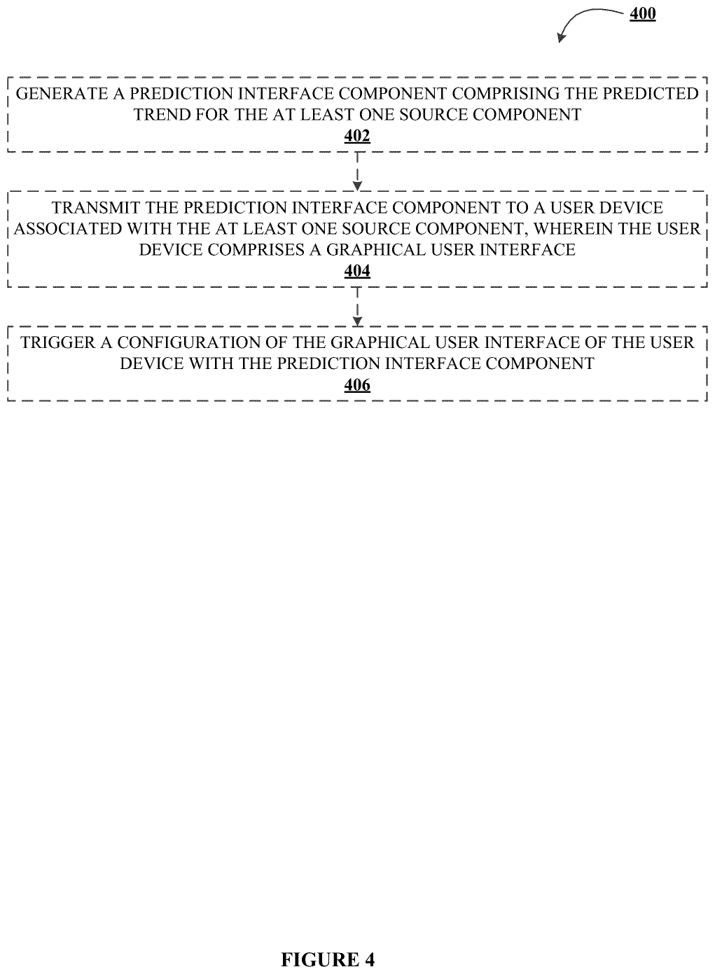

FIG. 4 illustrates a process flow 400 for trigging a configuration of a graphical user interface of a user device with a prediction interface component, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process flow 400.

In some embodiments, and as shown in block 402, the process flow 400 may include the step of generating a prediction interface component comprising the predicted trend for the at least one source component. For instance, and in some such embodiments, the system may generate a prediction interface component comprising the data of the predicted trend for at least the one source component, whereby the predicted trend may show not only the future prediction of the source component(s) but also the current performance of the source component(s) in real time or near real time. Further, and in some such embodiments, the prediction interface component may comprise the data of the predicted trend in a computer figurable format, such that the predicted trend and its data may be used to render a graphical user interface (GUI) of a user device that receives the prediction interface component with the data of the predicted trend. Thus, and in some such embodiments, the predicted trend data in the prediction interface component may comprise computer readable data which may be used to render the GUI of the user device to show the predicted trend's data in a human-readable format.

In some embodiments, and as shown in block 404, the process flow 400 may include the step of transmitting the prediction interface component to a user device associated with the at least one source component, wherein the user device comprises a graphical user interface. For instance, and in some such embodiments, the system may transmit the prediction interface component to a user device, whereby the user device may be associated with a manager of a manager of the system; a manager, operator, or owner of the at least one source component; and/or the like. In some such embodiments, the user device that will receive the prediction interface component may be pre-determined and set within the system (e.g., by a manager of the system selecting a user device and/or an associated user to receive the prediction interface component and/or by a manager of the source component(s) selecting the user device and/or the associated user to receive the prediction interface component). In some embodiments, the prediction interface component may be automatically transmitted to the user device in real time or near real time once the prediction interface component has been generated and/or updated.

In some embodiments, and as shown in block 406, the process flow 400 may include the step of triggering a configuration of the graphical user interface of the user device with the prediction interface component. For instance, and in some such embodiments, the system may trigger a configuration of the GUI of the recipient user device to automatically and in real time or near real time show the data of the predicted trend for the at least one source component to a user of the user device. In some such embodiments, the prediction interface component may comprise a plurality of predicted trends and their associated data for a plurality of source components, such that the configured GUI of the user device is not limited to only one source component and its predicted trend. In some embodiments, the prediction interface component may comprise at least one alert indicating when the data points of the predicted trend (e.g., current data point at the current instance, and/or a future data point for at least one future instance) are above a difference threshold from previous or historical metric data (e.g., which would indicate a major change to the performance of the source component at the current time and/or the future time). Such an embodiment is discussed in further detail hereinbelow with respect to FIG. 5.

FIG. 5 illustrates a process flow 500 for comparing the difference score to a difference threshold and updating a graphical user interface with an alert interface component or a dashboard interface component, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process flow 500.

In some embodiments, and as shown in block 502, the process flow 500 may include the step of determining a difference score between at least one of the metric data in the at least one bucket or the predicted trend and the historical metric data associated with the at least one source component. For instance, and in some such embodiments, the system may determine a difference score between the historical metric data and the metric data of the current instance and/or the historical metric data and the predicted trend data points. Such a difference score may comprise a numerical value indicating the difference in performance data from the historical metric data and the current performance data or the predicted performance data of the source component. By way of non-limiting example, and where the metric data indicates the response time of an application (i.e., the source component), and where the historical metric data of the application indicates a short response time (e.g., 0.01 seconds) as an average response time of the historical metric data, and the current metric data indicates a current response time of 5 seconds, then the difference score may comprise the numerical difference between 5 seconds and 0.01 seconds. Additionally, and/or alternatively, the same example may be used for a predicted trend, whereby a predicted trend may show the application will likely perform with a similar response time for most of its data points at 0.01 to 0.05 seconds, but at one data point within the predicted trend, the application's response time is 4 seconds, then the difference score may comprise the numerical difference between 4 seconds and 0.01 seconds.

In some embodiments, and as shown in block 504, the process flow 500 may include the step of comparing the difference score to a difference threshold. Thus, and in some embodiments, the system may comprise a difference threshold which may be pre-configured and/or pre-determined by the system itself (based on past performances of the source component(s) and their difference thresholds which indicated or coincided with a performance issue), by a manager of the system, by a manager of the source component, and/or the like. Thus, and by comparing the difference score to the difference threshold, the system may determine in what instance(s) the difference score indicates an issue in the performance of the source component.

In some embodiments, and as shown in block 506, the process flow 500 may include the step of determining, based on the comparison of the difference score and the difference threshold, the difference score meets or exceeds the difference threshold. For instance, and in some such embodiments, the system may determine—in an instance where the difference score is greater than or meets the difference threshold—a problem is likely occurring (currently if the difference score for the current metric data is associated with the difference score at issue, and/or at a future time if the difference score at issue is associated with a future data point of the predicted trend). For example, and where the difference score meets and/or exceeds the difference threshold, then the system may determine automatically that the source component associated with the difference score has a current or future issue with this the source component which must be addressed and mitigated or resolved.

In some embodiments, and as shown in block 508, the process flow 500 may include the step of generating an alert interface component comprising the difference score and the at least one of the metric data or the predicted trend the difference score is based on. Thus, and in some such embodiments, the system may generate an alert interface component which may comprise the data associated with the difference score. For instance, and in some embodiments, the data associated with the difference score may comprise the timestamp of the difference score that exceeds the difference threshold (e.g., whether the difference score at issue is associated with a current metric data and thus happening at a current time, whether the difference score at issue is associated with a future time of the predicted trend and will likely happen at a specific future time, and/or the like), the source component identifier of the difference score that exceeds the difference threshold (e.g., which may comprise the source component name, part number, application name, location within a datacenter, location within a computing environment, and/or the like), the metric data and/or the predicted data of the predicted trend associated with the difference score (e.g., a numerical value of the metric data which may indicate the performance of the source component, such as the number of errors detected, the response time, the downtime length, and/or the like, of the source component), and/or the like. In some embodiments, the data associated with the difference score may further comprise an identifier of the responsible entity or group for the source component, such as but not limited to the responsible information technology (IT) group that is tasked with overseeing and/or fixing any issues with the particular source component and/or the source component's location. Thus, and in such embodiments, the information of the alert interface component may be automatically forwarded or directly transmitted to a user device associated with the responsible entity or group.

In some embodiments, and as shown in block 510, the process flow 500 may include the step of transmitting the alert interface component to a user device associated with the at least one source component, wherein the user device comprises a graphical user interface. In some such embodiments, the system may transmit the alert interface component to a user device associated with the at least one source component, whereby the user device may be associated with a manager of the system; a manager, owner, or operator of the source component; a responsible entity or group of the source component or the source component's location; and/or the like. Further, and in some such embodiments, the user device that receives the alert interface component may comprise a graphical user interface (GUI) which may be configured to show the information of the alert interface component to the user of the user device in a human-readable format.

Additionally, and/or alternatively, the system may transmit the alert interface component to the user device that has already been currently configured to show the prediction interface component and/or the dashboard interface component. In this manner, the alert interface component may configure the view of the prediction interface component and/or the dashboard interface component to comprise a pop-up notification comprising the data of the alert interface component where the source component data in the prediction interface component and/or the dashboard interface component is shown (e.g., the pop-up may appear directly over and/or directly next to the data point indicating associated with the difference score at issue which is shown on the prediction interface component and/or the dashboard interface component).

In some embodiments, and as shown in bock 512, the process flow 500 may include the step of triggering a configuration of the graphical user interface of the user device with the alert interface component. For instance, and in some such embodiments, the system may trigger an automatic configuration of the GUI of the user device when the user device receives the alert interface component. Thus, and in some such embodiments, the system—by sending the alert interface component and its metadata to the user device—may cause (trigger) the configuration of the user device once the user device receives the alert interface component. Thus, and in some such embodiments, the alert interface component may be programmed or comprise code to automatically cause the configuration of the GUI at the recipient user device.

In some embodiments, and as shown in block 514, the process flow 500 may include the step of determining, based on the comparison of the difference score and the difference threshold, the difference score does not meet or exceed the difference threshold. For instance, and additionally and/or alternatively to the description provided above, the system may determine the difference score does not meet or exceed the difference threshold, and thus none of the source components are currently or will at a future predicted time have issues in their performances.

Importantly, the processes described herein throughout this application may be continuously and iteratively run—even in the instances where no issues are determined to currently occur or at a future time occur—and the current metric data may be continuously used to update the predicted trend each time the metric data is collected and used to generate the bucket(s) for the source component(s). Thus, the predicted trends and current performance data of the source components are as accurate as possible, while allowing for the least amount of data (e.g., every five minutes, every ten minutes, every fifteen minutes, every thirty minutes, every hour, and/or the like) to be analyzed by the system to generate its determinations of potential issues or problems in the source component performance.

In some embodiments, and as shown in block 516, the process flow 500 may include the step of updating a dashboard interface component with the difference score, wherein the dashboard interface component further comprises the metric data associated with the at least one source component at a current instance with the difference score. For instance, and in some such embodiments, the system may update the dashboard interface component with the difference score of the at least the current instance of the metric data, such that dashboard interface component may comprise the most up to date information on the performance data of the source component for each current instances as time goes on and no issues for performance are detected. Thus, the dashboard interface component may comprise an up to date snapshot or report of the source component(s) as the metric data is received for the source component(s).

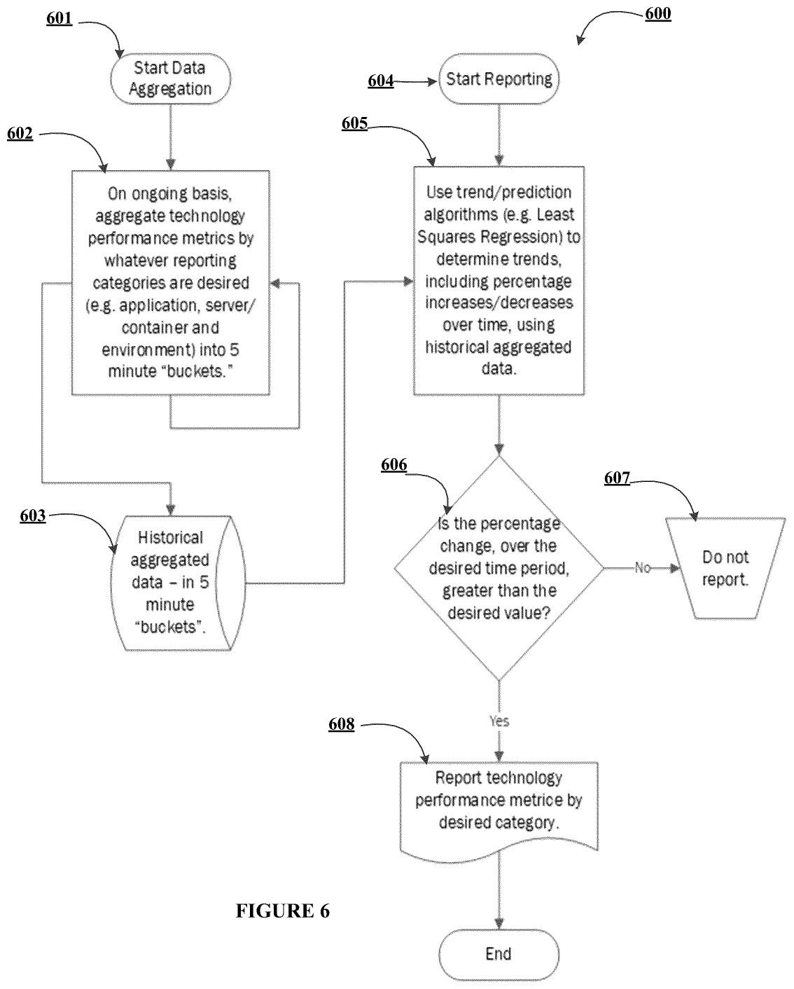

FIG. 6 illustrates a flow diagram 600 for monitoring and predicting technology component performance and generating real time alerts, in accordance with an embodiment of the disclosure. In some embodiments, a system (e.g., similar to one or more of the systems described herein with respect to FIGS. 1A-1C) may perform one or more of the steps of flow diagram 600. For example, a system (e.g., the system 130 described herein with respect to FIG. 1A-1C) may perform the steps of flow diagram 600.

As shown in flow diagram 600, the overall process described herein throughout this disclosure is provided as an overall flow diagram. For example, and as shown in block 601, the process may begin by starting the data aggregation (e.g., collecting the metric data associated with at least one source component). Further, and as shown in bock 602, the process may continue with aggregating technology performance metrics by whatever reporting categories are required (e.g., application, server/container and environment) into five minute buckets (e.g., the metric data aggregated may be associated with particular resource components that a user or manager of the system may wish to have current and predicted trends on for the component performances). Further, and as shown in block 603, the system may collect and/or store the historical aggregated data for the source components identified in block 602, which in some embodiments, may be stored in a similar manner to the buckets described in block 602 (e.g., in five minute buckets). Thus, the comparison of the current metric data and the historical metric data may be based on the same time for the data collection (e.g., every five minutes for collection may allow for the system to always analyze the performance on the hour, at five minutes after the hour, at ten minutes after the hour, at fifteen minutes past the hour, and/or the like).

Additionally, and as shown in block 604, the system may continue the process by starting the reporting section of the process (e.g., which may be tasked with generating the dashboard interface component, the prediction interface component, the alert interface component, and/or the like). As shown in block 605, the process may continue by using trend/prediction algorithms (e.g., the least squares regression algorithm described hereinabove) to determine trends, including percentage increases/decreases over time, using the historical aggregated data (from block 603). Thus, and as shown in block 603, the process may comprise the use of the prediction module (which may comprise the least squares regression algorithm) to determine the predicted trend of the source component(s) based on the current metric data and the historical metric data for each source component.

Further, and as shown in block 606, the process may continue in determining if the percentage change, over the desired time period, is greater than the desired value (e.g., is the difference score greater than or equal to the difference threshold). Thus, and in some such embodiments, the percentage change may comprise the difference score as a whole number, as an average number, as a percentage, and/or the like, and the percentage change may be compared to a threshold (e.g., the difference threshold) to determine if an issue is present for the source component(s). In some embodiments, and as shown in block 607, where the difference score does not meet or exceed the difference threshold, the system may not report any issues for the source component (e.g., the system may not generate and transmit an alert interface component to a user device associated with the source component). In some embodiments, and as shown in block 608, and where the difference score does meet or exceed the difference threshold, then the system may generate an alert to report the technology performance metrics by the desired category (e.g., based on the category of the source component, the category of the extremity in the predicted or determined issue, and/or the like).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for monitoring and predicting technology component performance and generating real time alerts, the system comprising:
a memory device with computer-readable program code stored thereon;
at least one processing device operatively coupled to the at least one memory device and the at least one communication device, wherein executing the computer-readable code is configured to cause the at least one processing device to:
collect, from at least one source component, metric data at a pre-defined interval;
cluster the metric data into at least one bucket based on a type of the metric data and the pre-defined interval;
collect historical metric data associated with the at least one source component at a plurality of historical pre-defined intervals;
apply the at least one bucket and the historical metric data associated with the at least one source component to a prediction module; and
determine, by the prediction module, a predicted trend for the at least one source component.

2. The system of claim 1, wherein the prediction module comprises at least one of a least squares regression algorithm, a linear regression algorithm, a polynomial regression algorithm, a KMeans clustering algorithm, or a stepwise regression algorithm.

3. The system of claim 1, wherein the predicted trend comprises a linear trend.

4. The system of claim 1, wherein the pre-defined interval comprises at least one of a five minute interval, a minute interval, a ten minute interval, a fifteen minute interval, a thirty minute interval, or an hour interval.

5. The system of claim 1, wherein executing the computer-readable code is further configured to cause the at least one processing device to:
generate a dashboard interface component comprising the metric data associated with the at least one source component at a current instance;
transmit the dashboard interface component to a user device associated with the at least one source component, wherein the user device comprises a graphical user interface; and
trigger a configuration of the graphical user interface of the user device with the dashboard interface component.

6. The system of claim 1, wherein executing the computer-readable code is further configured to cause the at least one processing device to:
generate a prediction interface component comprising the predicted trend for the at least one source component;
transmit the prediction interface component to a user device associated with the at least one source component, wherein the user device comprises a graphical user interface; and
trigger a configuration of the graphical user interface of the user device with the prediction interface component.

7. The system of claim 1, wherein executing the computer-readable code is further configured to cause the at least one processing device to:
determine a difference score between at least one of the metric data in the at least one bucket or the predicted trend and the historical metric data associated with the at least one source component; and
compare the difference score to a difference threshold.

8. The system of claim 7, wherein executing the computer-readable code is further configured to cause the at least one processing device to:
determine, based on the comparison of the difference score and the difference threshold, the difference score meets or exceeds the difference threshold;
generate an alert interface component comprising the difference score and the at least one of the metric data or the predicted trend the difference score is based on;
transmit the alert interface component to a user device associated with the at least one source component, wherein the user device comprises a graphical user interface; and
trigger a configuration of the graphical user interface of the user device with the alert interface component.

9. The system of claim 7, wherein executing the computer-readable code is further configured to cause the at least one processing device to:
determine, based on the comparison of the difference score and the difference threshold, the difference score does not meet or exceed the difference threshold; and
update a dashboard interface component with the difference score, wherein the dashboard interface component further comprises the metric data associated with the at least one source component at a current instance with the difference score.

10. A computer program product for monitoring and predicting technology component performance and generating real time alerts, the computer program product comprising a non-transitory computer-readable medium comprising code causing an apparatus to:
collect, from at least one source component, metric data at a pre-defined interval;
cluster the metric data into at least one bucket based on a type of the metric data and the pre-defined interval;
collect historical metric data associated with the at least one source component at a plurality of historical pre-defined intervals;
apply the at least one bucket and the historical metric data associated with the at least one source component to a prediction module; and
determine, by the prediction module, a predicted trend for the at least one source component.

11. The computer program product of claim 10, wherein the prediction module comprises at least one of a least squares regression algorithm, a linear regression algorithm, a polynomial regression algorithm, a KMeans clustering algorithm, or a stepwise regression algorithm.

12. The computer program product of claim 10, wherein the predicted trend comprises a linear trend.

13. The computer program product of claim 10, wherein the pre-defined interval comprises at least one of a five minute interval, a minute interval, a ten minute interval, a fifteen minute interval, a thirty minute interval, or an hour interval.

14. The computer program product of claim 10, wherein the computer program product comprising the non-transitory computer-readable medium comprising code further causes the apparatus to:
generate a dashboard interface component comprising the metric data associated with the at least one source component at a current instance;
transmit the dashboard interface component to a user device associated with the at least one source component, wherein the user device comprises a graphical user interface; and
trigger a configuration of the graphical user interface of the user device with the dashboard interface component.

15. The computer program product of claim 10, wherein the computer program product comprising the non-transitory computer-readable medium comprising code further causes the apparatus to:
generate a prediction interface component comprising the predicted trend for the at least one source component;
transmit the prediction interface component to a user device associated with the at least one source component, wherein the user device comprises a graphical user interface; and
trigger a configuration of the graphical user interface of the user device with the prediction interface component.

16. A computer implemented method for monitoring and predicting technology component performance and generating real time alerts, the computer implemented method comprising:
collecting, from at least one source component, metric data at a pre-defined interval;
clustering the metric data into at least one bucket based on a type of the metric data and the pre-defined interval;
collecting historical metric data associated with the at least one source component at a plurality of historical pre-defined intervals;
applying the at least one bucket and the historical metric data associated with the at least one source component to a prediction module; and
determining, by the prediction module, a predicted trend for the at least one source component.

17. The computer implemented method of claim 16, wherein the prediction module comprises at least one of a least squares regression algorithm, a linear regression algorithm, a polynomial regression algorithm, a KMeans clustering algorithm, or a stepwise regression algorithm.

18. The computer implemented method of claim 16, wherein the predicted trend comprises a linear trend.

19. The computer implemented method of claim 16, wherein the pre-defined interval comprises at least one of a five minute interval, a minute interval, a ten minute interval, a fifteen minute interval, a thirty minute interval, or an hour interval.

20. The computer implemented method of claim 16, further comprising:
generating a dashboard interface component comprising the metric data associated with the at least one source component at a current instance;
transmitting the dashboard interface component to a user device associated with the at least one source component, wherein the user device comprises a graphical user interface; and
triggering a configuration of the graphical user interface of the user device with the dashboard interface component.
